(19) United States
(12) Patent Application Publication
(10) Pub. No.: US 2016/0295847 A1
(43) Pub. Date: Oct. 13, 2016

(54) FISHING BAIT HOLDING SYSTEM

(71) Applicant: Robert McKinstry, Charlotte, NC (US)

(72) Inventor: Robert McKinstry, Charlotte, NC (US)

(21) Appl. No.: 14/683,756

(22) Filed: Apr. 10, 2015

(51) Int. Cl. A01K 97/06; A47B 96/00; A47B 97/00; A47B 81/00

(52) U.S. Cl. CPC A01K 97/06; A47B 81/00; A47B 96/00; A47B 97/00

(57) ABSTRACT

A fishing bait holding system includes a housing has a bottom wall and a perimeter wall that is attached to and extends upwardly from the bottom wall. The perimeter wall has an upper edge defining an opening into the housing and the perimeter wall includes a front wall, a rear wall, a first side wall and a second side wall. The housing is water impermeable and holds a quantity of fishing bait. A lid is hingedly coupled to the housing and the lid is positioned in closed position abutting the upper edge or positioned in an open position allowing access to the interior of the housing. A coupler is attached to the housing. The coupler releasably secures the housing to a barrier.

### BACKGROUND OF THE DISCLOSURE

### Field of the Disclosure

The disclosure relates to fishing bait holders and more particularly pertains to a new fishing bait holder for holding bait in a secure fashion while fishing.

### SUMMARY OF THE DISCLOSURE

An embodiment of the disclosure meets the needs presented above by generally comprising a housing has a bottom wall and a perimeter wall that is attached to and extends upwardly from the bottom wall. The perimeter wall has an upper edge defining an opening into the housing and the perimeter wall includes a front wall, a rear wall, a first side wall and a second side wall. The housing is water impermeable and configured to hold fishing bait. A lid is hingedly coupled to the housing and the lid is positioned in closed position abutting the upper edge or positioned in an open position allowing access to the interior of the housing. A coupler is attached to the housing. The coupler releasably secures the housing to a barrier.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a fishing bait holding system according to an embodiment of the disclosure.

FIG. 2 is a top perspective view of an embodiment of the disclosure.

FIG. 3 is a front view of an embodiment of the disclosure including a mount as described below.

FIG. 4 is a side view of an embodiment of the disclosure.

FIG. 5 is a side view of an embodiment of the disclosure.

FIG. 6 is a side view of embodiments of a mount of the disclosure.

### DESCRIPTION OF THE PREFERRED EMBODIMENT

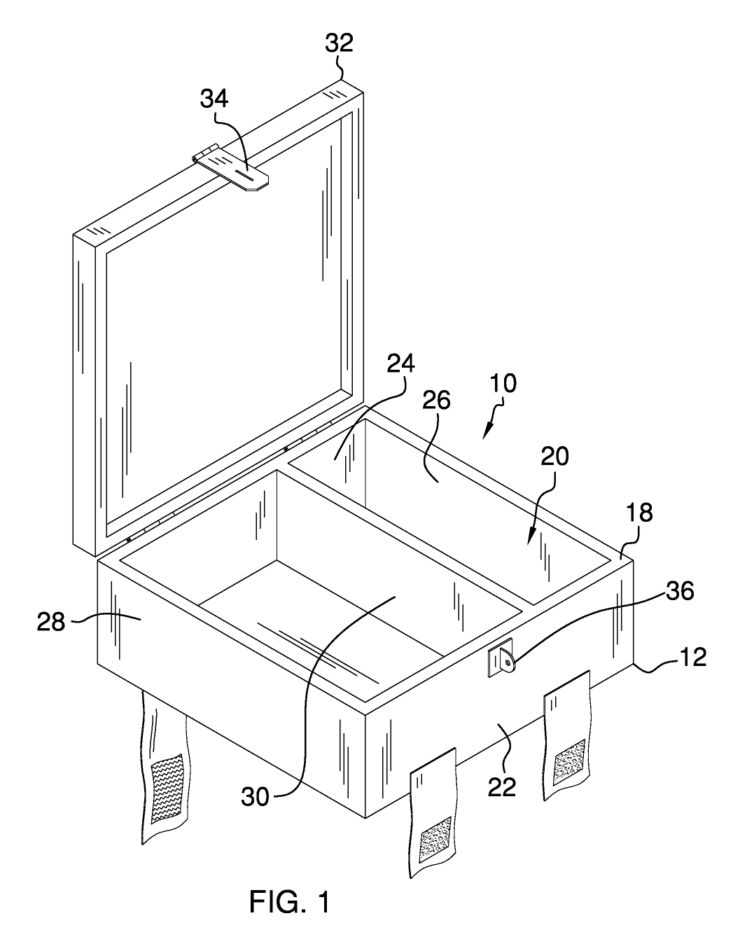

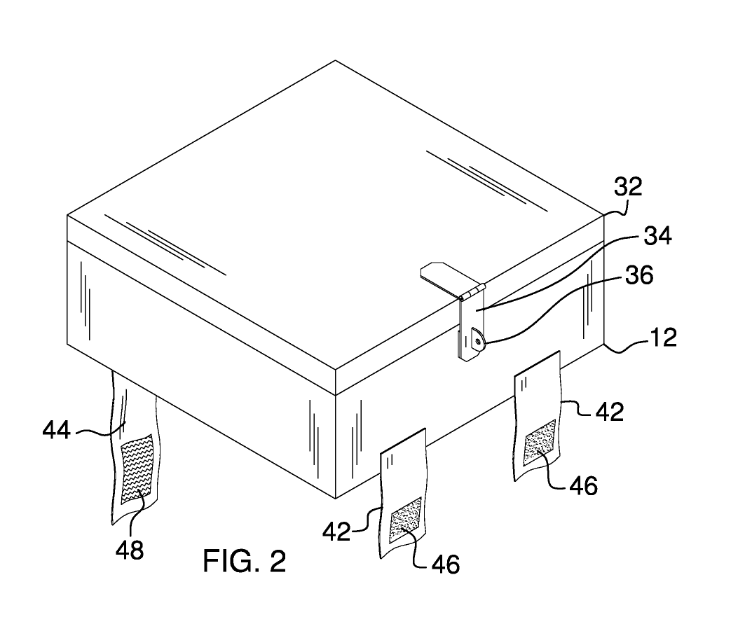

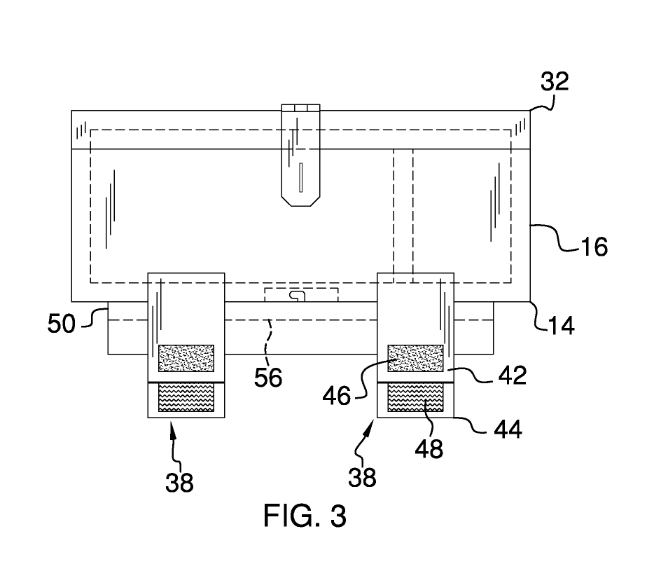

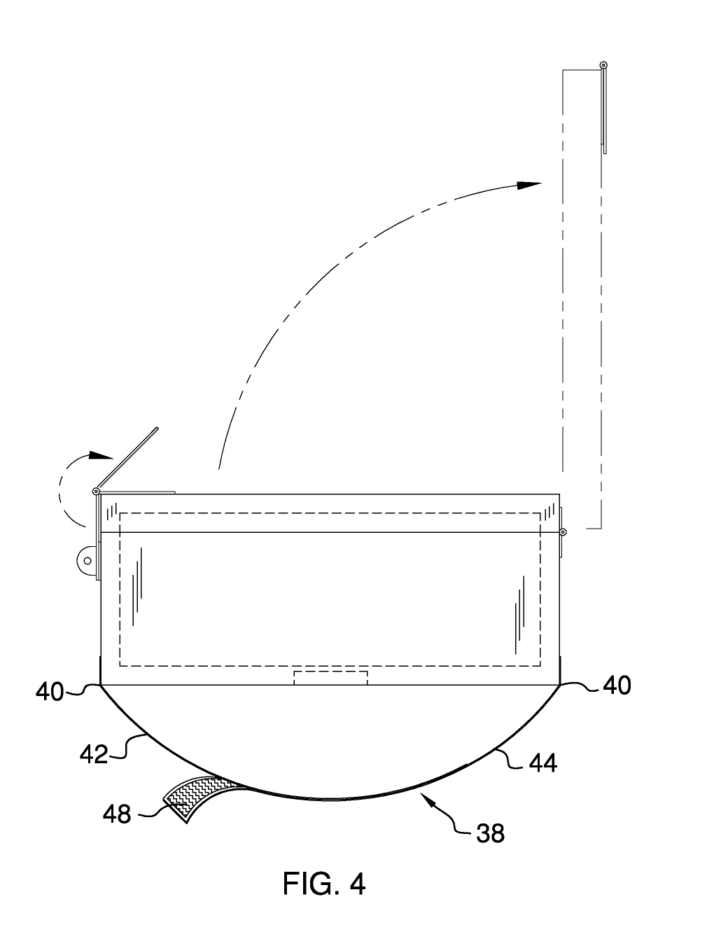

With reference now to the drawings, and in particular to FIGS. 1 through 6 thereof, a new fishing bait holder embodying the principles and concepts of an embodiment of the disclosure and generally designated by the reference numeral 10 will be described.

As best illustrated in FIGS. 1 through 6, the fishing bait holding system 10 generally comprises a housing 12 having a bottom wall 14 and a perimeter wall 16 that is attached to and extends upwardly from the bottom wall 14. The perimeter wall 16 has an upper edge 18 defining an opening 20 into the housing 12. The housing 12 may have any useful size but typically will have a width and depth between 8 inches and 16 inches and a height less than 12 inches. The perimeter wall 16 includes a front wall 22, a rear wall 24, a first side wall 26 and a second side wall 28. The housing 12 is water impermeable and the housing 12 is therefore configured to hold fishing bait which may include minnows and leaches held within water or earthworms, grubs and the like which may be held in a soil or soil-like medium. A dividing wall 30 may be mounted within the housing 12 and extends upwardly from the bottom wall 14 to divide an interior of the housing 12 into two sections. The sections are fluidly sealed with respect to each other so that one may contain water while the other remains dry.

A lid 32 is hingedly coupled to the housing 12. The lid 32 is positioned in closed position abutting the upper edge 18 or positioned in an open position allowing access to the interior of the housing 12. A latch 34 is attached to the lid 32 and is removably securable to the perimeter wall 16 to retain the lid 32 in the closed position. As can be seen the latch 34 may receive a loop 36 through which a lock may be extended to lock the lid 32 in the closed position. Generally, however, the lid 32 will prevent birds or other animals from attempting to enter the housing 12 and steal bait therefrom.

A coupler 38 is attached to the housing 12. The coupler 38 is configured to releasably secure the housing 12 to a barrier 39. The barrier 39 may include a wall of a boat or a top of a guard rail such as would be found on a pier. The coupler 38 may include a pair of straps 40 wherein each of the straps 40 has a pair of ends 42 attached to the housing 12 adjacent to the bottom wall 14. Each of the straps 40 has a break therein such that each strap 40 includes a first strap section 42 and a second strap section 44. The first strap sections 42 each have a first mating member 46 attached thereto and each of the second strap sections 44 has a second mating member 48 attached thereto. The associated ones of the first 42 and second 44 strap sections are releasably coupled to each other with the first 46 and second 48 mating members. The first 46 and second 48 mating members may comprise hook and loop couplers.

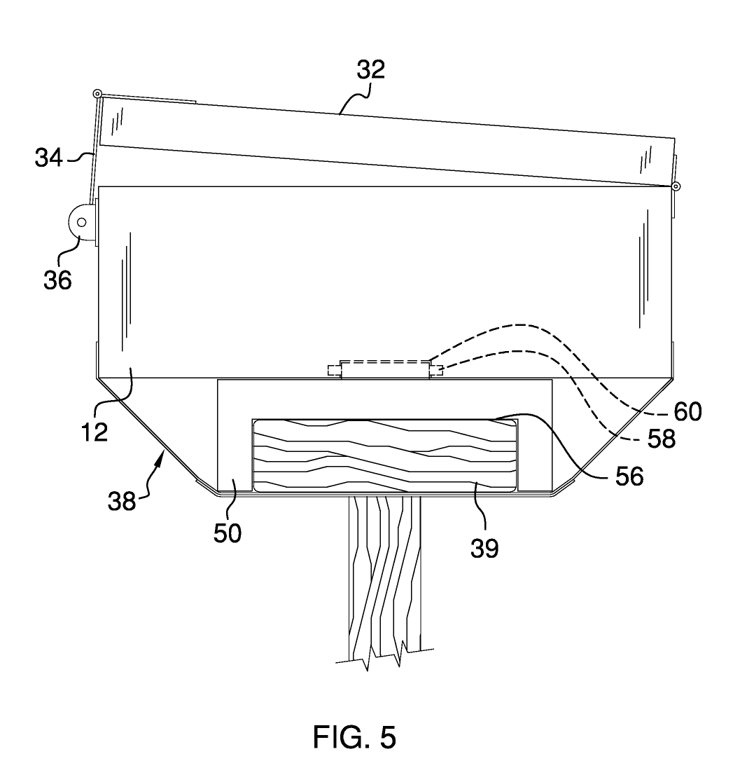

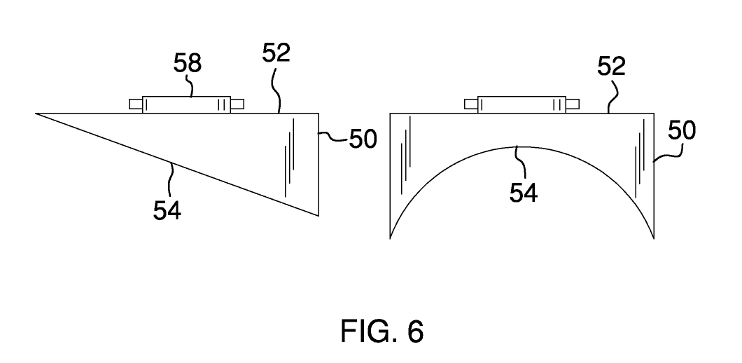

A mount 50 may be utilized, if need, that is removably attached to a bottom surface of the bottom wall 14. The mount 50 has an upper surface 52 and a lower surface 54. The lower surface 54 has a shape configured to contour to and abut a top side of the barrier. As can be seen in FIG. 5, the mount 50 may include a rectangular slot 56 for receiving the barrier 39 which is horizontally oriented and has a rectangular shape. FIG. 6 show alternate shapes that may be utilized for barriers 39 having an angled or rounded top surface. A connector 58 is attached to and extends upwardly from the upper surface 52. The connector 58 is removably extendable into and releasably engageable with the bottom wall 14 by fitting into a notch 60 in the bottom wall 14.

In use, the housing 12 is filled with the desired bait, or baits, and then placed in an area adjacent to the person fishing for easy access. The housing 12 is secured to the barrier 39 with the coupler 38 and with, or without, the mount 50 should it be needed. The bait may then be accessed as needed without fear of spillage or birds stealing the bait.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing bait holding system comprising:
a housing having a bottom wall and a perimeter wall being attached to and extending upwardly from said bottom wall, said perimeter wall having an upper edge defining an opening into said housing, said perimeter wall including a front wall, a rear wall, a first side wall and a second side wall, said housing being water impermeable, wherein housing is configured to hold fishing bait;
a lid being hingedly coupled to said housing, said lid being positioned in closed position abutting said upper edge or positioned in an open position allowing access to said interior of said housing;
a coupler being attached to said housing, said coupler being configured to releasably secure said housing to a barrier.

2. The fishing bait holding system according to claim 1, wherein said coupler includes a pair of straps, each of said straps having a pair of ends attached to said housing adjacent to said bottom wall, each of said straps having a break therein such that each strap includes a first strap section and a second strap section, said first strap sections each having a first mating member attached thereto and each of said second strap sections having a second mating member attached thereto, wherein associated ones of said first and second strap sections are releasably coupled to each other with said first and second mating members.

3. The fishing bait holding system according to claim 1, further including a dividing wall being mounted within said housing, said dividing wall extending upwardly from said bottom wall and dividing said interior into two sections.

4. The fishing bait holding system according to claim 3, wherein said sections are fluidly sealed with respect to each other.

5. The fishing bait holding system according to claim 1, further including a mount being removably attached to a bottom surface of said bottom wall, said mount having an upper surface and a lower surface, said lower surface having a shape configured to contour to and abut a top side of the barrier, a connector being attached to and extending upwardly from said upper surface, said connector being removably extendable into and releasably engageable with said bottom wall.

6. The fishing bait holding system according to claim 1, further including a latch being attached to said lid and being removably securable to said perimeter wall to retain said lid in said closed position.

7. A fishing bait holding system comprising:
a housing having a bottom wall and a perimeter wall being attached to and extending upwardly from said bottom wall, said perimeter wall having an upper edge defining an opening into said housing, said perimeter wall including a front wall, a rear wall, a first side wall and a second side wall, said housing being water impermeable, wherein housing is configured to hold fishing bait;
a lid being hingedly coupled to said housing, said lid being positioned in closed position abutting said upper edge or positioned in an open position allowing access to said interior of said housing;
a coupler being attached to said housing, said coupler being configured to releasably secure said housing to a barrier, said coupler including a pair of straps, each of said straps having a pair of ends attached to said housing adjacent to said bottom wall, each of said straps having a break therein such that each strap includes a first strap section and a second strap section, said first strap sections each having a first mating member attached thereto and each of said second strap sections having a second mating member attached thereto, wherein associated ones of said first and second strap sections are releasably coupled to each other with said first and second mating members;
a dividing wall being mounted within said housing, said dividing wall extending upwardly from said bottom wall and dividing said interior into two sections, said sections being fluidly sealed with respect to each other;
a mount being removably attached to a bottom surface of said bottom wall, said mount having an upper surface and a lower surface, said lower surface having a shape configured to contour to and abut a top side of the barrier, a connector being attached to and extending upwardly from said upper surface, said connector being removably extendable into and releasably engageable with said bottom wall; and
a latch being attached to said lid and being removably securable to said perimeter wall to retain said lid in said closed position.
